(19) United States
(12) Patent Application Publication
(10) Pub. No.: US 2010/0304918 A1
(43) Pub. Date: Dec. 2, 2010

(54) PLANETARY CARRIER ASSEMBLY WITH INTEGRATED PARK GEAR FOR A TRANSMISSION

(75) Inventors: Boris Burgman, Oak Park, MI (US); Sara A. Stabenow, Whitmore Lake, MI (US); John Daniel Beres, III, Canton, MI (US)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., Detroit, MI (US)

(21) Appl. No.: 12/474,573

(22) Filed: May 29, 2009

(51) Int. Cl. F16H 57/08; B23P 11/00

(52) U.S. Cl. 475/331; 29/428

(57) ABSTRACT

A planetary carrier assembly for a transmission includes a first carrier portion and a second carrier portion. The first carrier portion includes a spider flange portion and at least one first carrier arm half extending along the longitudinal axis. The second carrier portion includes a park gear flange and at least one second carrier arm half extending along the longitudinal axis into abutting engagement with the at least one first carrier arm half. The first carrier arm halves and the second carrier arm halves are welded together at an approximate midsection along the longitudinal axis between the spider flange portion and the park gear flange portion to minimize internal stresses within the output shaft assembly.

### TECHNICAL FIELD

The present invention generally relates to a planetary carrier assembly for a transmission of a vehicle, and more specifically to a planetary carrier assembly having an integral parking gear.

### BACKGROUND OF THE INVENTION

Planetary carrier assemblies for transmissions typically include a spider attached to a plate. The spider may include a spider flange portion and a plurality of arm portions extending outward from the spider flange portion along a longitudinal axis to the plate. The arm portions are welded to or in some other manner attached to the plate. The planetary carrier may be connected to a shaft to form a shaft assembly if so desired. Alternatively, the entire planetary carrier may be cast or machined as a solid unitary manufacture.

Transmissions also utilize a parking gear to prevent torque transfer to the wheels of the vehicle. The parking gear is typically coupled to an output shaft either directly or through one or more gears. A park lock mechanism is selectively engageable with the parking gear to prevent torque transfer when engaged and permit torque transfer when disengaged.

### SUMMARY OF THE INVENTION

A planetary carrier assembly for a transmission includes a first carrier portion including a spider flange portion extending radially outward from a longitudinal axis. The first carrier portion further includes at least one first carrier arm half extending from the spider flange portion along the longitudinal axis. A second carrier portion is longitudinally spaced from the first carrier portion along the longitudinal axis. The second carrier portion includes a park gear flange portion extending radially outward from the longitudinal axis, and at least one second carrier arm half extending from the park gear flange portion along the longitudinal axis. The at least one second carrier arm half extends into abutting engagement with the first carrier arm half. The at least one first carrier arm half includes a first alignment feature and the at least one second carrier arm half includes a second alignment feature. The second alignment feature includes a shape complimentary to the first alignment feature for mating with the first alignment feature to align the second carrier portion with the first carrier portion relative to the longitudinal axis.

In another embodiment, a transmission for a vehicle is provided. The transmission includes a shaft portion having a first end and extending along a longitudinal axis to a second end. A planetary carrier assembly is coupled to the shaft portion adjacent the second end. The planetary carrier assembly includes a first carrier portion attached to the shaft portion adjacent the second end. The first carrier portion includes a spider flange portion extending from the shaft portion radially outward from the longitudinal axis, and further includes at least one first carrier arm half extending from the spider flange portion along the longitudinal axis. The planetary carrier assembly further includes a second carrier portion longitudinally spaced from the first carrier portion along the longitudinal axis. The second carrier portion includes a park gear flange portion extending radially outward from the longitudinal axis, and at least one second carrier arm half extending from the park gear flange portion along the longitudinal axis. The at least one second carrier arm half extends into abutting engagement with the first carrier arm half. A welded connection interconnects the at least one first carrier arm half and the at least one second carrier arm half. The welded connection is disposed on a radial outer surface of the at least one first carrier arm half and the at least one second carrier arm half. The at least one first carrier arm half includes a first lip extending from a radial inner surface of the at least one first carrier arm half along the longitudinal axis. The at least one second carrier arm half includes a second lip extending from a radial outer surface of the at least one second carrier arm half along the longitudinal axis. The first lip and the second lip are disposed in overlapping engagement along the longitudinal axis to align the second carrier portion with the first carrier portion relative to the longitudinal axis.

A method of assembling a planetary carrier assembly for a transmission of a vehicle is also provided. The method includes providing a first carrier portion having a spider flange portion and at least one first carrier arm half extending perpendicularly from an outer periphery of the spider flange portion. The method further includes providing a second carrier portion having a park gear flange portion and at least one second carrier arm half extending perpendicularly from the park gear flange portion. The method further includes aligning the second carrier portion with the first carrier portion such that the park gear flange portion is longitudinally spaced from and parallel with the spider flange portion and the at least one second carrier arm half extends along the longitudinal axis into abutting engagement with the at least one first carrier arm half. The method further includes welding the at least one second carrier arm half and the at least one first carrier arm half together along an outer periphery of the at least one first carrier arm half and the at least one second carrier arm half to attach the second carrier portion to the first carrier portion.

Accordingly, the first carrier portion and the second carrier portion are connected by welding the at least one first carrier arm half and the at least one second carrier arm half together. The at least one first carrier arm half and the at least one second carrier arm half extend from the spider flange portion and the park gear flange portion toward each other to meet at an approximate midway point along the longitudinal axis between the spider flange portion and the park gear flange portion. The welded connection is disposed between the spider flange portion and the park gear flange portion to minimize the internal stresses created when the first carrier portion and the second carrier portion are welded together. By welding the first carrier portion and the second carrier portion together in a location that minimizes the internal stresses, the geometric shape of the first carrier portion and the second carrier portion may be optimized to reduce the weight of the components. Additionally, the material utilized for the first carrier portion and the second carrier portion may be selected for optimal welding and strength based upon the design requirements of each.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a perspective view of a transmission for a vehicle showing an output shaft assembly coupled to an input shaft.

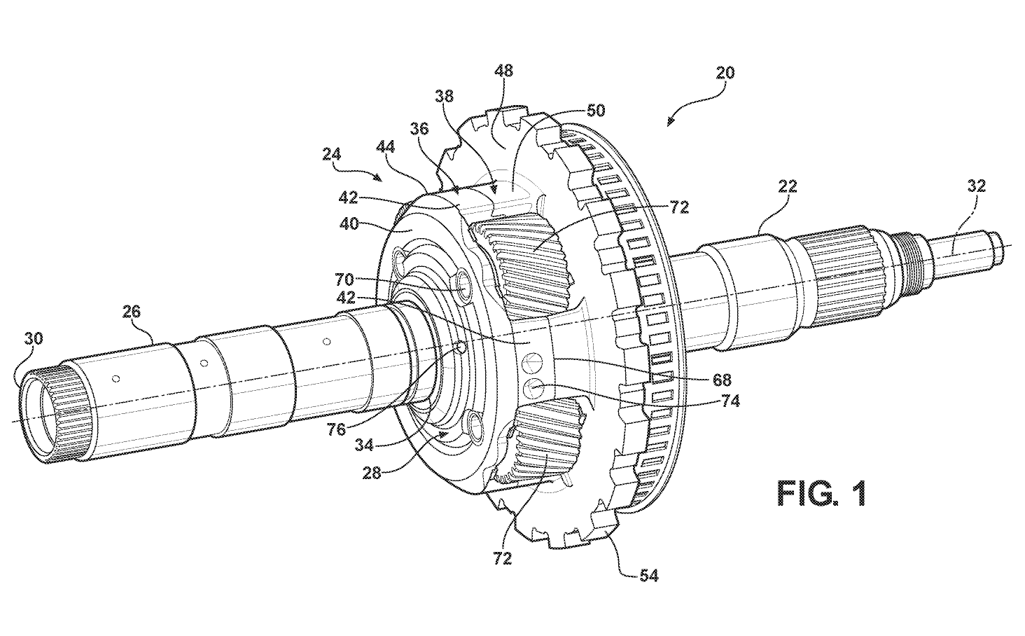

FIG. 2 is a perspective view of the output shaft assembly.

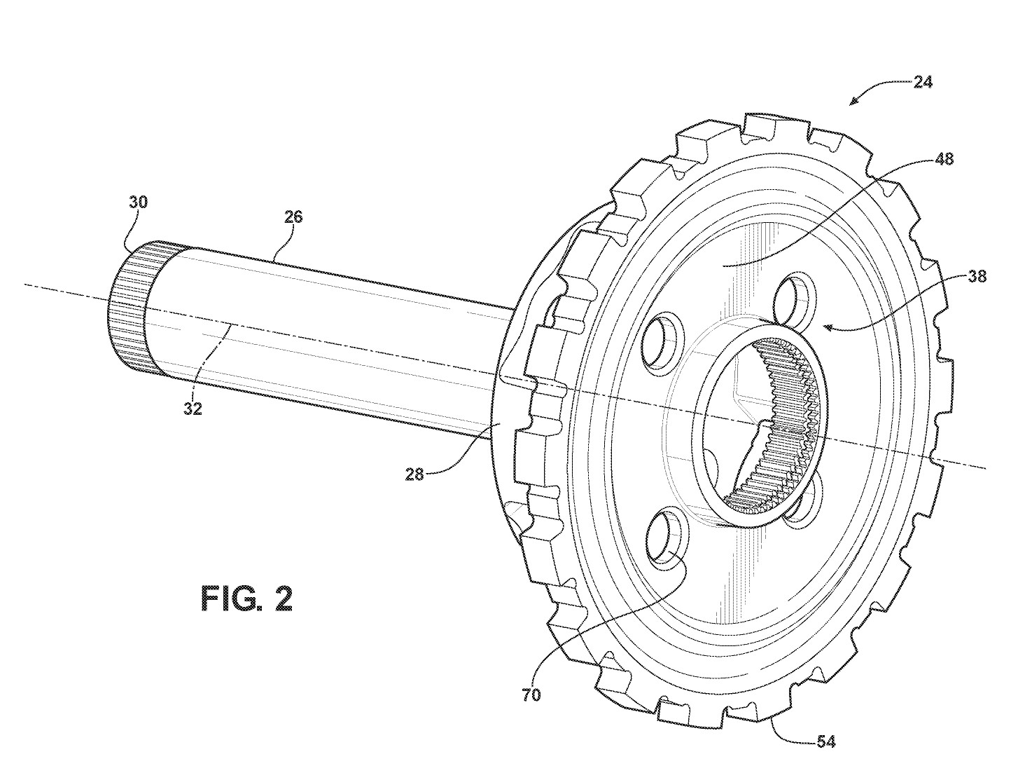

FIG. 3 is a cross sectional view of the output shaft assembly.

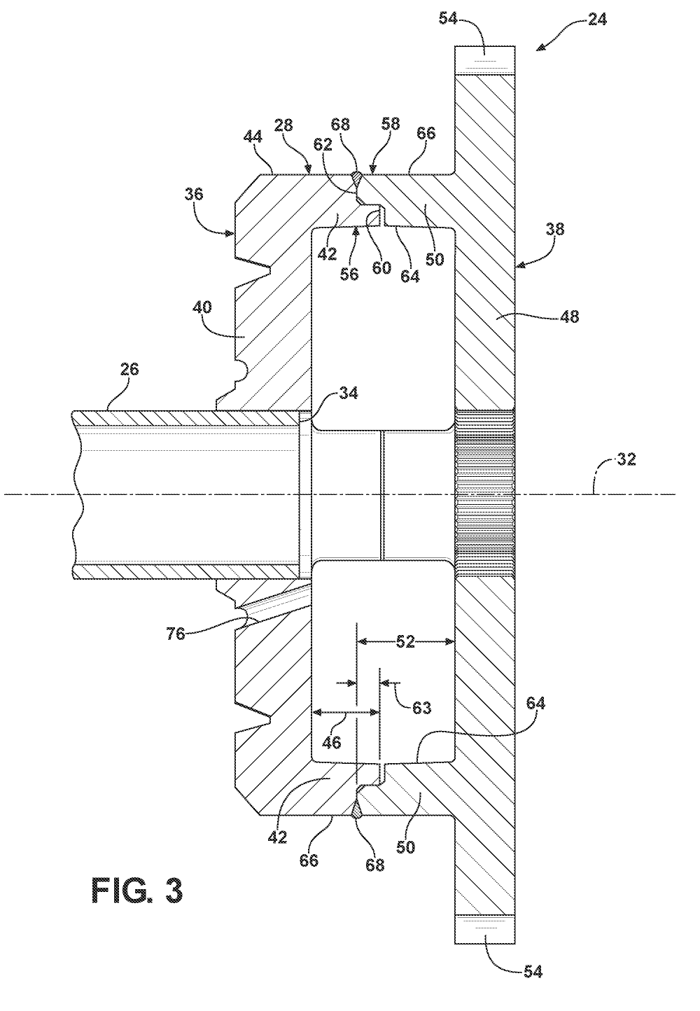

### DESCRIPTION OF THE PREFERRED EMBODIMENTS

Referring to the Figures, wherein like numerals indicate like parts throughout the several views, a transmission is shown generally at 20. The transmission 20 is for a vehicle (not shown), and transmits a torque between an engine (not shown) of the vehicle and at least one wheel (not shown) of the vehicle. The transmission 20 may be part of an automatic transmission. However, it should be appreciated that the transmission 20 may alternatively be part of a manual transmission.

The transmission 20 includes an output shaft 22 and a carrier shaft assembly 24. The output shaft 22 is configured for transmitting the torque to the wheels of the vehicle. The carrier shaft assembly 24 is coupled to the output shaft 22 through a plurality of gears.

The carrier shaft assembly 24 includes a shaft portion 26 and a planetary carrier 28 attached to the shaft portion 26. The shaft portion 26 includes a first end 30, and extends along a longitudinal axis 32 to a second end 34. The planetary carrier assembly 28 may be attached to the shaft portion 26 adjacent the second end 34 of the shaft portion 26. However, it should be appreciated that the planetary carrier need not be attached to the shaft portion.

The planetary carrier assembly 28 includes a first carrier portion 36 and a second carrier portion 38. As shown, the first carrier portion 36 is attached to the shaft portion 26 adjacent the second end 34 of the shaft portion 26. Preferably, the first carrier portion 36 is welded to the shaft portion 26. However, it should be appreciated that the first carrier portion 36 may be attached to the shaft portion 26 in some other manner suitable to fixedly connect the first carrier portion 36 to the shaft portion 26 and transmit a torque, i.e., rotational movement about the longitudinal axis 32, between the first carrier portion 36 and the shaft portion 26. As such, it should be appreciated that the first carrier portion 36 and the shaft portion 26 may be connected through a splined connection, a bolted connection, or some other similar type of connection.

Preferably, the first carrier portion 36 includes a low carbon steel. Preferably, the low carbon steel may include American Iron and Steel Institute (AISI) Grade 1010 low carbon steel, or some other similar low carbon steel. The material utilized for the first carrier portion 36 may be selected to optimize one of cost, strength, weight, weldability, or some other material characteristic. Accordingly, it should be appreciated that the first carrier portion 36 may include and be manufactured from a material other than the low carbon steel described herein.

The first carrier portion 36 includes a spider flange portion 40 and at least one first carrier arm half 42. The spider flange portion 40 extends from the shaft portion 26 radially outward from the longitudinal axis 32 to an outer periphery 44. As such, the spider flange portion 40 is oriented perpendicularly relative to the longitudinal axis 32. The at least one first carrier arm half 42 extends from the outer periphery 44 of the spider flange portion 40 along the longitudinal axis 32. Accordingly, the at least one first carrier arm half 42 extends parallel to the longitudinal axis 32, is laterally spaced from the longitudinal axis 32, and is oriented perpendicularly relative to the spider flange portion 40.

The at least one first carrier arm half 42 extends from the first carrier portion 36 a first distance 46. Preferably, the at least one first carrier arm half 42 includes four first carrier arm halves 42. However, it should be appreciated that the number of the first carrier arm halves 42 may vary depending upon design considerations.

The second carrier portion 38 is longitudinally spaced from the first carrier portion 36 along the longitudinal axis 32. Preferably, the second carrier portion 38 includes a medium carbon steel. Preferably, the medium carbon steel may include American Iron and Steel Institute (AISI) Grade 1552 medium carbon steel, or some other similar medium carbon steel. The material utilized for the second carrier portion 38 may be selected to optimize one of cost, strength, weight, weldability, or some other material characteristic. Accordingly, it should be appreciated that the second carrier portion 38 may include and be manufactured from a material other than the medium carbon steel described herein.

The second carrier portion 38 includes a park gear flange portion 48 and at least one second carrier arm half 50. The park gear flange portion 48 extends radially outward from the longitudinal axis 32. As such, the park gear flange portion 48 is oriented perpendicularly relative to the longitudinal axis 32 and parallel with and spaced from the spider flange portion 40 of the first carrier portion 36. The at least one second carrier arm half 50 extends from the park gear flange portion 48 along the longitudinal axis 32 into abutting engagement with the first carrier arm half 42. As such, the at least one second carrier arm half 50 extends parallel to the longitudinal axis 32, is laterally spaced from the longitudinal axis 32, and is oriented perpendicularly relative to the park gear flange portion 48.

The at least one second carrier arm half 50 extends from the second carrier portion 38 a second distance 52 in a direction opposite the first carrier arm halves 42. Preferably, the first distance 46 is substantially equal to the second distance 52 such that the first carrier arm halves 42 and the second carrier arm halves 50 meet at an approximate middle between the spider flange portion 40 and the park gear flange portion 48. However, it should be appreciated that the first distance 46 may differ from the second distance 52, with the first distance 46 and the second distance 52 being pre-determined based upon design considerations related to the material properties associated with the first carrier portion 36 and the second carrier portion 38.

Preferably, the at least one second carrier arm half 50 includes four second carrier arm halves 50. However, it should be appreciated that the number of the second carrier arm halves 50 may vary depending upon design considerations. Furthermore, it should be appreciated that the number of first carrier arm halves 42 is equal to the number of second carrier arm halves 50. Preferably, the first carrier arm halves 42 and the second carrier arm halves 50 are arranged radially about the longitudinal axis 32 and equidistantly spaced from each other about a circular alignment concentric with the longitudinal axis 32. However, it should be appreciated that the first carrier arm halves 42 and the second carrier arm halves 50 may be arranged about the longitudinal axis 32 in some other manner not shown or described herein.

The park gear flange includes a plurality of lugs 54 extending radially outward from an outer periphery 44 of the park gear flange. A park lock mechanism (not shown) selectively engages at least one of the lugs 54 to prevent torque transfer from the planetary carrier assembly 28 and the output shaft 22. Accordingly, when activated by an operator, the park lock mechanism is actuated to engage at least one of the lugs 54 and prevent rotation of the park gear flange. When disengaged by the operator, the park lock mechanism releases the lugs 54 of the park gear flange, thereby allowing torque transfer between the planetary carrier assembly 28 and the output shaft 22. Typically, the park lock mechanism includes a pawl (not shown) pivotable into and out of engagement with the lugs 54 for selectively engaging and disengaging the lugs 54. However, it should be appreciated that the park lock mechanism may include any suitable mechanism known to those skilled in the art for selectively engaging and disengaging the lugs 54 of the park gear flange.

The at least one first carrier arm half 42 includes a first alignment feature 56, and the at least one second carrier arm half 50 includes a second alignment feature 58. The first alignment feature 56 of the first carrier arm halves 42 and the second alignment feature 58 of the second carrier arm halves 50 each include a shape that is complimentary to each other. The complimentary shapes of the first alignment feature 56 and the second alignment feature 58 permits the first alignment feature 56 and the second alignment feature 58 to mate with each other to align the second carrier portion 38 with the first carrier portion 36 relative to the longitudinal axis 32.

As shown, the first alignment feature 56 includes a first lip 60 extending from the at least one first carrier arm half 42 along the longitudinal axis 32, and the second alignment feature 58 includes a second lip 62 extending from the at least one second carrier arm half 50 along the longitudinal axis 32. The first lip 60 and the second lip 62 are disposed in overlapping engagement along the longitudinal axis 32 an overlap distance 63. The first lip 60 extends from a radial inner surface 64 of the first carrier arm half 42 and the second lip 62 extends from a radial outer surface 66 of the second carrier arm half 50. Accordingly, when assembled, the second lip 62 of the second carrier arm halves 50 slide over the first lip 60 of the first carrier arm halves 42, with the second lip 62 being disposed radially further from the longitudinal axis 32 than the first lip 60. It should be appreciated that the first alignment feature 56 and the second alignment feature 58 may be configured in some other manner not shown or described herein capable of aligning the second carrier portion 38 with the first carrier portion 36 along the longitudinal axis 32.

The carrier shaft assembly 24 includes a welded connection 68 interconnecting the at least one first carrier arm half 42 and the at least one second carrier arm half 50. The welded connection 68 attaches the second carrier portion 38 to the first carrier portion 36. The welded connection 68 is disposed on the radial outer surface 66 of the at least one first carrier arm half 42 and the at least one second carrier arm half 50. Accordingly, the welded connection 68 is disposed at the joint between the first carrier arm halves 42 and the second carrier arm halves 50. As described above, the first carrier arm halves 42 and the second carrier arm halves 50 preferably meet at an approximate middle along the longitudinal axis 32 between the spider flange portion 40 and the park gear flange portion 48. Locating the welded connection 68 at this location minimizes the internal stresses created by welding the first carrier portion 36 and the second carrier portion 38 together, thereby permitting a reduction in material thickness of the first carrier portion 36 and the second carrier portion 38, and permitting the materials utilized for the first carrier portion 36 and the second carrier portion 38 to be selected to minimize cost and maximize strength based upon the specific design considerations. It should be appreciated that it is the combination of the low carbon steel of the first carrier portion 36 and the medium carbon steel of the second carrier portion 38 that permits the welded connection 68 to be disposed at the approximate midsection between the spider flange portion 40 and the park gear flange portion 48.

The first carrier portion 36 and the second carrier portion 38 each define a plurality of aligned bores 70. The aligned bores 70 extend along and are radially spaced from the longitudinal axis 32. The opposing pairs of the aligned bores 70 are configured for supporting one of a plurality of planetary pinion gears 72 between the spider flange portion 40 and the park gear flange portion 48.

The planetary carrier assembly 28 may be balanced after assembly for rotation about the longitudinal axis 32. The planetary carrier assembly 28 is balanced by boring at least one recess 74 into at least one of the first carrier arm halves 42 and/or one of the second carrier arm halves 50. The number, size and location of the at least one recess 74 is dependent upon the specific balancing requirements of each individual carrier shaft assembly 24.

The spider flange portion 40 and/or the park gear flange portion 48 may include one or more oil ports 76 extending therethrough. The oil ports 76 permit a lubricant to flow into the space defined between the spider flange portion 40 and the park gear flange portion 48 to lubricate the plurality of planetary pinion gears 72 disposed therein.

The subject invention also provides a method of assembling the planetary carrier assembly 28. The method comprises providing the shaft portion 26 having the first end 30 and extending along the longitudinal axis 32 to the second end 34.

The method further comprises providing the first carrier portion 36 having the spider flange portion 40 and the at least one first carrier arm half 42 extending perpendicularly from an outer periphery 44 of the spider flange portion 40. Providing the first carrier portion 36 having the at least one first carrier arm half 42 may further be defined as providing the first carrier portion 36 with at least one first carrier arm half 42 having a first lip 60 extending outward along the longitudinal axis 32 from a radial inner surface 64 of the at least one first carrier arm half 42.

The method further comprises attaching the first carrier portion 36 to the second end 34 of the shaft portion 26. The first carrier portion 36 is attached such that the spider flange portion 40 extends radially outward from the longitudinal axis 32 and the at least one first carrier arm half 42 extends along the longitudinal axis 32. Attaching the first carrier portion 36 to the second end 34 of the shaft portion 26 may further be defined as welding the first carrier portion 36 to the shaft portion 26. However, it should be appreciated that other methods may be utilized to attach the first carrier portion 36 to the shaft portion 26.

The method further comprises providing the second carrier portion 38 having the park gear flange portion 48 and the at least one second carrier arm half 50 extending perpendicularly from the park gear flange portion 48. Providing the second carrier portion 38 having the at least one second carrier arm half 50 may further be defined as providing the second carrier portion 38 with the at least one second carrier arm half 50 having the second lip 62 extending outward along the longitudinal axis 32 from a radial outer surface 66 of the at least one second carrier arm half 50.

The method further comprises aligning the second carrier portion 38 with the first carrier portion 36. The second carrier portion 38 is aligned with the first carrier portion 36 such that the park gear flange portion 48 is longitudinally spaced from and parallel with the spider flange portion 40, and the at least one second carrier arm half 50 extends along the longitudinal axis 32 into abutting engagement with the at least one first carrier arm half 42. Aligning the second carrier portion 38 with the first carrier portion 36 may further be defined as aligning the first lip 60 in overlapping engagement along the longitudinal axis 32 with the second lip 62, with the second lip 62 disposed radially further from the longitudinal axis 32 than the first lip 60. It should be appreciated that the first carrier portion 36 and the second carrier portion 38 may be aligned in some other manner other than shown or described herein.

The method further comprises welding the at least one second carrier arm half 50 and the at least one first carrier arm half 42 together. The second carrier arm halves 50 and the first carrier arm halves 42 are welded along a radial outer surface of the first carrier arm halves 42 and the second carrier arm halves 50 to attach the second carrier portion 38 to the first carrier portion 36. The welding may be accomplished in any suitable manner and with any suitable device for the specific materials utilized in the first carrier portion 36 and the second carrier portion 38. The specific welding techniques and devices used therefore are well known to those skilled in the art, and are therefore not discussed in detail herein.

The method further comprises balancing the planetary carrier assembly 28 for rotation about the longitudinal axis 32. Balancing the planetary carrier assembly 28 may further be defined as boring the at least one recess 74 into one of the at least one first carrier arm half 42 and the at least one of the second carrier arm half 50. Boring the recess 74 into one of the first carrier arm halves 42 and the second carrier arm halves 50 preferably occurs after the first carrier portion 36 and the second carrier portion 38 are welded together. The boring is preferably achieved through use of a drilling tool to remove enough material to rotationally balance the carrier shaft assembly 24 about the longitudinal axis 32. However, the boring may be achieved through any suitable manner with the use of any suitable device known to those skilled in the art.

While the best modes for carrying out the invention have been described in detail, those familiar with the art to which this invention relates will recognize various alternative designs and embodiments for practicing the invention within the scope of the appended claims.

1. A planetary carrier assembly for a transmission, the planetary carrier assembly comprising:
a first carrier portion including a spider flange portion extending radially outward from a longitudinal axis and at least one first carrier arm half extending from said spider flange portion along said longitudinal axis; and
a second carrier portion longitudinally spaced from said first carrier portion along said longitudinal axis and including a park gear flange portion extending radially outward from said longitudinal axis and further including at least one second carrier arm half extending from said park gear flange portion along said longitudinal axis into abutting engagement with said first carrier arm half;
said at least one first carrier arm half including a first alignment feature and said at least one second carrier arm half including a second alignment feature having a shape complimentary to said first alignment feature for mating with said first alignment feature to align said second carrier portion with said first carrier portion relative to said longitudinal axis.

2. A planetary carrier assembly as set forth in claim 1 wherein said first alignment feature includes a first lip extending from said at least one first carrier arm half along said longitudinal axis and said second alignment feature includes a second lip extending from said at least one second carrier arm half along said longitudinal axis with said first lip and said second lip disposed in overlapping engagement along said longitudinal axis.

3. A planetary carrier assembly as set forth in claim 2 wherein said first lip extends from a radial inner surface of said first carrier arm half and said second lip extends from a radial outer surface of said second carrier arm half with said second lip disposed radially further from said longitudinal axis than said first lip.

4. A planetary carrier assembly as set forth in claim 1 wherein said at least one first carrier arm half extends from said first carrier portion a first distance and wherein said at least one second carrier arm half extends from said second carrier portion a second distance, with said first distance being substantially equal to said second distance.

5. A planetary carrier assembly as set forth in claim 1 further comprising a welded connection interconnecting said at least one first carrier arm half and said at least one second carrier arm half for attaching said second carrier portion to said first carrier portion.

6. A planetary carrier assembly as set forth in claim 5 wherein said welded connection is disposed on a radial outer surface of said at least one first carrier arm half and said at least one second carrier arm half.

7. A planetary carrier assembly as set forth in claim 5 wherein said first carrier portion includes a low carbon steel.

8. A planetary carrier assembly as set forth in claim 7 wherein said second carrier portion includes a medium carbon steel.

9. A planetary carrier assembly as set forth in claim 1 wherein said at least one first carrier arm half includes four first carrier arm halves and wherein said at least one second carrier arm half includes four second carrier arm halves.

10. A planetary carrier assembly as set forth in claim 1 wherein said first carrier portion and said second carrier portion each define a plurality of aligned bores extending along and radially spaced from said longitudinal axis and configured for supporting a plurality of planetary pinion gears.

11. A planetary carrier assembly as set forth in claim 1 wherein said park gear flange includes a plurality of lugs extending radially outward from an outer periphery of said park gear flange for engaging a park lock mechanism.

12. A transmission for a vehicle, the transmission comprising:
a shaft portion having a first end and extending along a longitudinal axis to a second end; and
a planetary carrier assembly coupled to said shaft portion adjacent said second end, said planetary carrier assembly including:
a first carrier portion attached to said shaft portion adjacent said second end and including a spider flange portion extending from said shaft portion radially outward from said longitudinal axis and further including at least one first carrier arm half extending from said spider flange portion along said longitudinal axis;
a second carrier portion longitudinally spaced from said first carrier portion along said longitudinal axis and including a park gear flange portion extending radially outward from said longitudinal axis and further including at least one second carrier arm half extending from said park gear flange portion along said longitudinal axis into abutting engagement with said first carrier arm half; and
a welded connection interconnecting said at least one first carrier arm half and said at least one second carrier arm half and disposed on a radial outer surface of said at least one first carrier arm half and said at least one second carrier arm half;
wherein said at least one first carrier arm half includes a first lip extending from a radial inner surface of said at least one first carrier arm half along said longitudinal axis and wherein said at least one second carrier arm half includes a second lip extending from a radial outer surface of said at least one second carrier arm half along said longitudinal axis with said first lip and said second lip disposed in overlapping engagement along said longitudinal axis to align said second carrier portion with said first carrier portion relative to said longitudinal axis.

13. A transmission as set forth in claim 12 wherein said at least one first carrier arm half extends from said first carrier portion a first distance and wherein said at least one second carrier arm half extends from said second carrier portion a second distance, with said first distance being substantially equal to said second distance.

14. A transmission as set forth in claim 13 wherein said first carrier portion includes a low carbon steel and wherein said second carrier portion includes a medium carbon steel.

15. A method of assembling a planetary carrier assembly for a transmission of a vehicle, the method comprising:
aligning a second carrier portion, having a park gear flange portion and at least one second carrier arm half extending perpendicularly from the park gear flange portion, with a first carrier portion, having a spider flange portion and at least one first carrier arm half extending perpendicularly from an outer periphery of the spider flange portion, such that the park gear flange portion is longitudinally spaced from and parallel with the spider flange portion and the at least one second carrier arm half extends along the longitudinal axis into abutting engagement with the at least one first carrier arm half; and
welding the at least one second carrier arm half and the at least one first carrier arm half together along a radial outer surface of the at least one first carrier arm half and the at least one second carrier arm half to attach the second carrier portion to the first carrier portion.

16. A method as set forth in claim 15 wherein the first carrier portion includes at least one first carrier arm half having a first lip extending outward along the longitudinal axis from a radial inner surface of the at least one first carrier arm half, and the second carrier portion includes at least one second carrier arm half having a second lip extending outward along the longitudinal axis from a radial outer surface of the at least one second carrier arm half.

17. A method as set forth in claim 16 wherein aligning the second carrier portion with the first carrier portion is further defined as aligning the first lip in overlapping engagement along the longitudinal axis with the second lip.

18. A method as set forth in claim 15 further comprising balancing the output shaft assembly for rotation about the longitudinal axis.

19. A method as set forth in claim 18 wherein balancing the output shaft assembly is further defined as boring at least one recess into one of the at least one first carrier arm half and the at least one of the second carrier arm half.

20. A method as set forth in claim 1 wherein the planetary carrier assembly includes a shaft portion having a first end and extending along a longitudinal axis to a second end and wherein the method includes attaching the first carrier portion to the second end of the shaft portion.
